(19) United States
(12) Patent Application Publication
(10) Pub. No.: US 2026/0100919 A1
(43) Pub. Date: Apr. 9, 2026

(54) UNICAST AGGREGATION WITH MINIMAL PIPELINE FLUSHING IN WIRELESS COMMUNICATION NETWORKS

(71) Applicant: TrellisWare Technologies, Inc., San Diego, CA (US)

(72) Inventors: Changwen Liu, San Diego, CA (US); Keith Chugg, San Diego, CA (US)

(21) Appl. No.: 18/910,434

(22) Filed: Oct. 9, 2024

(51) Int. Cl. H04L 49/201; H04L 5/00

(52) U.S. Cl. CPC H04L 49/201; H04L 5/0012

(57) ABSTRACT

Methods and systems that improve network performance in time-slotted multi-hop wireless networks, e.g., a Barrage Relay network, are described. In an aspect, the broadcast nature of the Barrage Relay network is leveraged to enable a source node to aggregates unicast packets across multiple destinations with the same priority in one Medium Access Control (MAC) Protocol Data Unit (MPDU). This aggregation advantageously enables a single request message to be sent to a network controller for multiple unicast packets destined for multiple destinations, thereby reducing the contention channel access significantly. In addition, minimal pipeline flushing allows the source node to be scheduled sooner than is required to fully flush the spatial pipeline. This advantageously enables scheduling of queued source nodes to minimize the sum switching delay.

### FIELD OF THE INVENTION

The present document relates to the field of multi-hop wireless networks, and in particular, to the field of efficient communication protocols.

### BACKGROUND

Efficiency in a time-slotted network refers to the ability of the network to effectively utilize the available time slots for transmitting data. In a time-slotted network, each device is allocated a specific time slot during which it can transmit data. The efficiency of the network is determined by factors such as the number of time slots available, the duration of each time slot, and the amount of data that can be transmitted within a single time slot. Higher efficiency means that the network can transmit more data within a given time frame, maximizing the utilization of available resources. This is particularly important in time-sensitive applications where data needs to be transmitted quickly and efficiently.

Modern commercial and military applications require increased efficiency with respect to information dissemination throughout a wireless network, and thus, there is a need for network protocols that enable efficiency network communication.

### SUMMARY

Methods, systems, and devices that use a combination of unicast aggregation and minimal pipeline flushing in a time-slotted, multi-hop wireless network are disclosed.

In an example aspect, a method for wireless communication in a time-slotted multi-hop wireless network with a network diameter of D hops and a spatial reuse factor of M is described. The method, which is implemented by a second source node, includes receiving, from a first source node via a plurality of intermediate nodes, a first packet data unit (PDU) in a first timeslot, and further receiving a plurality of packets. Herein, the first source node and the second source node are h hops away. Herein, the second source node overhears a first aggregated PDU sent by the first source node. The method then includes identifying, using a destination field in each of the plurality of packets, a first set of packets to be transmitted to a first destination node and a second set of packets to be transmitted to a second destination node, and then aggregating the first set of packets and the second set of packets into a second PDU. The method concludes with broadcasting, in a second timeslot that is min (M, D-h) timeslots after the first timeslot (in which the first aggregated PDU was broadcast by the first source node), the second PDU.

In another example aspect, a method for wireless communication in a time-slotted multi-hop wireless network with a network diameter of D hops and a spatial reuse factor of M is described. The method includes receiving, from a first source node, a first request message for resources to broadcast a first packet data unit (PDU). Herein, a first set of packets to a first destination node and a second set of packets to a second destination node are aggregated into the first PDU. The method then includes allocating, in response to the first request message, a first timeslot, and transmitting, to the first source node, an indication of the first timeslot. Then, the method includes receiving, from a second source node, a second request message for resources to broadcast a second PDU, in which a third set of packets to the first destination node and a fourth set of packets to the second destination node have been aggregated. The method further includes making a determination that the second source node is h hops away from the first source node, allocating, in response to the second request message based on the determination, a second timeslot that is min (M+h, D) timeslots after the first timeslot, and transmitting, to the second source node, an indication of the second timeslot.

In the above-described methods, each destination node receives a PDU via one or more intermediate nodes. Herein, each destination node and each intermediate node (of the one or more intermediate nodes) is configured to receive multiple instances of a packet. Each intermediate node is further configured to constructively combine energy from a first subset of the multiple instances of the packet before relaying a constructively combined packet via a broadcast operation, and each destination node is further configured to constructively combine energy from a second subset of the multiple instances of the packet before decoding the constructively combined packet.

In yet another example aspect, a wireless communication apparatus that implements the above-described methods is disclosed.

In yet another example aspect, a wireless system in which the above-described methods are implemented is disclosed.

In yet another example aspect, the above-described methods may be embodied as processor-executable code and may be stored on a computer-readable program medium.

These, and other, features are described in this patent document.

### BRIEF DESCRIPTION OF THE DRAWINGS

Drawings described herein are used to provide a further understanding and constitute a part of this application. Example embodiments and illustrations thereof are used to explain the technology rather than limit its scope.

FIGS. 1A-IC show example slot assignments for a time-slotted multi-hop network.

FIG. 2 shows an example broadcast flooding protocol (e.g., the Barrage Relay protocol) for a time-slotted multi-hop network.

FIG. 3 shows an example of a time-slotted multi-hop network that was implemented to demonstrate the efficacy of the described embodiments.

FIGS. 4A and 4B show examples of the baseline transmission of broadcast MAC PDUs (MPDUs) and the unicast aggregated transmission of the broadcast MPDUs, respectively.

FIGS. 5A and 5B show numerical results for the unicast aggregated transmission.

FIGS. 6A and 6B show corresponding numerical results for the baseline transmission.

FIG. 7 shows additional numerical results showing the efficacy of the unicast aggregated transmission as compared to the baseline transmission.

FIG. 8 shows an example 6-hop network to define minimal pipeline flushing (MPF).

FIG. 9 shows numerical results demonstrating the efficacy of minimal pipeline flushing in time-slotted multi-hop networks of varying network diameters and number of source nodes.

FIGS. 10A-10D show the efficacy of MPF in an 8-hop network with 6 source nodes.

FIGS. 11A-11D show the efficacy of MPF in an 8-hop network with 12 source nodes.

FIGS. 12A-12D show the efficacy of MPF in an 8-hop network with 24 source nodes.

FIGS. 13A-13D show the efficacy of MPF in a 40-hop network with 32 source nodes.

FIG. 14 shows a flowchart for an example method of wireless communication.

FIG. 15 shows a flowchart for another example method of wireless communication.

FIG. 16 shows an example hardware implementation that can be configured to implement one or more of the described embodiments.

### DETAILED DESCRIPTION

To make the purposes, technical solutions and advantages of this disclosure more apparent, various embodiments are described in detail below with reference to the drawings. Unless otherwise noted, embodiments and features in embodiments of the present document may be combined with each other.

Section headings are used in the present document to improve readability of the description and do not in any way limit the discussion or the embodiments to the respective sections only. Accordingly, one or more features of one section can be combined with one or more features of another section. Furthermore, Barrage Relay network terminology is used for the sake of clarity of explanation, but the techniques disclosed in the present document are not limited to implementations of Barrage Relay networking only, and may be used in other time-slotted multi-hop wireless networks that implement other flooding protocols.

### 1 Introduction and Networking Overview

Embodiments of the disclosed technology can be implemented in a multi-hop, time-slotted wireless network. That is, a wireless network that can implement a time-division multiple access (TDMA) scheme that divides a unit of time (for example, one second, which may be referred to as a frame) into slots, each of which are dedicated for the transmissions and reception of messages from nodes that may be multiple hops from each other. Without loss of generality, timeslots for transmission may be consecutive or assigned at specific times within the frame, wherein the latter approach is typically referred to as a “virtual channel” or a “logical channel.”

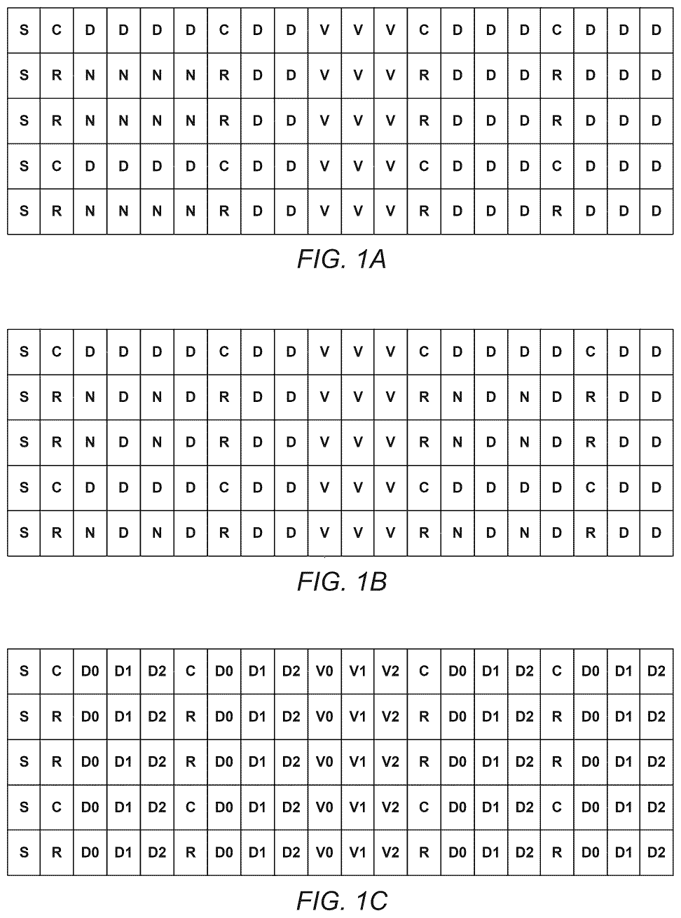

In some examples, the representative slot assignments shown in FIGS. 1A, 1B and 1C define virtual channels for different types of messages including synchronization, data and voice messages. Table 1 provides a legend for some of the types of slots assigned within a frame.

TABLE 1
Logical channels used in slot assignments

| | |
|---|---|
| S | Synchronization logical channel |
| C | Clear-to-send logical channel |
| R | Request-to-send logical channel |
| N | Network maintenance logical channel |
| D | Data logical channel |
| V | Voice logical channel |

The disclosed embodiments include operations that are described in the context of “subsequent timeslots” or timeslots that are “N timeslots after” a particular timeslot. It is noted that subsequent timeslots can represent either the very next timeslot in time, or as in the context of FIGS. 1A, 1B and 1C, the very next timeslot that has been assigned to that particular type of message. That is, a subsequent timeslot can be the very next timeslot in the virtual (or logical) channel, and not necessarily subsequent in time. Similarly, a timeslot that is N timeslots after a particular timeslot (e.g., with index ‘a’) can represent either the (a+N)th timeslot or a timeslot that is N timeslots after timeslot a in a particular virtual (or logical) channel.

A Barrage Relay network (BRn), which is an example of a time-slotted multi-hop wireless network that supports embodiments of the disclosed technology, is shown in FIG. 2. As shown therein, independent medium allocations in the BRn are determined via a time-division multiple access (TDMA) scheme. While BRns can be defined according to various medium allocation schemes (e.g., time-slotting, different frequency channels, different antenna radiation patterns, low cross-correlation spreading sequences), the disclosed technology is described in the context of a time-slotted barrage relay network.

In this framework, time is divided into frames, which are further divided into multiple slots per frame (for example, FIG. 2 employs 3 slots per frame labeled “A,” “B” and “C”). The data that is transmitted in a given time slot is denoted a “packet.” Two packets that are transmitted by two different nodes are said to be identical if all data-including all protocol header information-contained in the respective packets is identical.

As shown in FIG. 2, a central node 101 transmits a packet on slot A of the first TDMA frame. All nodes that successfully receive this packet are, by definition, one hop away from the source; these nodes are labeled 111, 112 . . . 117 in FIG. 2. These nodes transmit the same packet on slot B, thus relaying to nodes that are two hops away from the source node (nodes 121, 122 . . . 129), which in turn transmit the same packet on slot C. Nodes that are three hops away from the source node (nodes 131, 132 . . . 137) relay the packet on slot A of the second TDMA frame. Thus, packets transmit outward from the source node via a decode-and-forward approach, e.g., the intermediate or relay nodes receive a packet, decode the packet, and then forward the packet after it is reassembled to nodes that two hops away from the source node.

A number of two-hop nodes receive the same packet from different one-hop nodes. These packets do not collide due to the physical (PHY) layer processing employed by BRns. In particular, BRns employ a PHY layer that allows identical packets to be combined at the receiver in a manner analogous to multipath mitigation in traditional radio receivers. That is, the multiple, time-shifted copies of the received signal that arise in BRns can be interpreted at the receiver as resulting not from different transmitting nodes, but from reflections off, for example, buildings when a single source node transmits.

In order for two packets to be identical, both the payload data and all protocol header data must be identical. Therefore, protocol headers in a barrage relay network can be modified only in a manner that is common across all nodes at a given hop distance from the source node. This is in stark contrast to traditional layered network architectures that employ a point-to-point link abstraction at Layer 2, wherein protocol headers can be modified in a node-specific—as opposed to a hop-specific—manner.

In the Barrage Relay network, the spatial reuse of time slots enables packets to be pipelined into the source node for transmission every three slots. Specifically, as shown in FIG. 2, the one-hop nodes will not receive the packet broadcast by the three-hop nodes during slot A of the second TDMA frame. Thus, the source node can safely transmit a second packet during that slot. In this manner, a throughput of W/3 can be achieved for broadcast in a BRn with a single source node (and wherein W is the capacity of a single point-to-point link). This efficient injection of messages for broadcast transmission is denoted “spatial pipelining” in order to highlight its reuse of time slots between spatially separated nodes.

More generally, spatial pipelining can be achieved by having a source node inject a new packet for every barrage relay broadcast every M slots resulting in a throughput of W/M. In this context, M is referred to as the spatial pipelining factor. In some embodiments, when the size of an arbitrary wireless network is not known to the source node a priori, M must be at least 3 to avoid collisions. Larger spatial pipelining factors (e.g. 4) may be chosen in order to enhance robustness in highly mobile network topologies. When a source node transmits its last packet the spatial pipeline must be flushed or cleared. Nominally the time to flush the pipeline is the number of hops in the network (network diameter in hops). This can cause a significant “switching cost” between source nodes which is more costly when the source nodes are transmitting messages with a small number of packets or the network has a large hop diameter.

Furthermore, in order to contain the extent of a given Barrage Relay transmission, two fields can be incorporated into the header (preamble) of each data packet: a time-to-live (TTL) field and a hop count (HC) field. The TTL field is unchanged by relaying nodes while the HC field is initially set to 1 by the source of the packet and incremented upon relay. In the context of FIG. 2, the central node 101 may set the TTL field to 8, and enable the packet to propagate over 8 hops through the BRn. The one-hop neighbors of this central node would receive such packets and relay a modified packet with the HC field set to 2. Similarly, two-hop neighbors set the HC to 3, and so on. Relaying continues whenever a received packet has an HC field that is less than or equal to the TTL field, but stops if this condition cannot be satisfied.

Although the description of the interaction between the TTL and HC fields is in the context of BRns, the notion of increasing the HC field upon relaying and stopping the relaying process when a packet with equal TTL and HC fields is received is not limited to BRns, and is compatible with wireless networks, in general.

In some configurations, the example Barrage Relay network shown in FIG. 2 includes a network controller node (denoted the NTR) that is configured to operate as a time reference for the network (and to which other nodes synchronize to) and define (or set) the TDMA schedule for a predefined duration (e.g., frame duration or packet duration). In an example, the NTR defines a TDMA schedule for a frame by assigning the slots in the frame, e.g., for a specific node for a type of signaling (e.g., uplink or downlink, control or data), for a particular logical channel (e.g., as defined in Table 1 above), etc. In another example, the NTR will receive a request for slots (or more generally, resources) from a particular node that wants to transmit data (a request-to-send, or RTS, message), and will reply with an assignment of slots to that particular node (a clear-to-send, or CTS, message).

Embodiments of the disclosed technology are configured to provide operational improvements in time-slotted, multi-hop wireless networks, such as the Barrage Relay network described above, that include increased throughput and more efficient communications. In some examples, this is achieved by a source node implementing both unicast aggregation (UA) and minimal pipeline flushing. A network node can independently enable, and implement, these techniques when operating as a source node, i.e., without needing to coordinate with any other non-NTR nodes. Furthermore, the throughput and efficiency gains due to the unicast aggregation and minimal pipeline flushing techniques are additive because their operating mechanisms are independent, which motivates their combination in contrast to merging other techniques with overlapping benefits.

In some embodiments, the scheduled transmission time slots of the MPDUs for the UA-enabled source node can follow the minimal pipeline flushing (MPF) to take full advantage of the MPF efficiency at the same time for the additive effect.

### 2 Example Embodiments for Unicast Aggregation

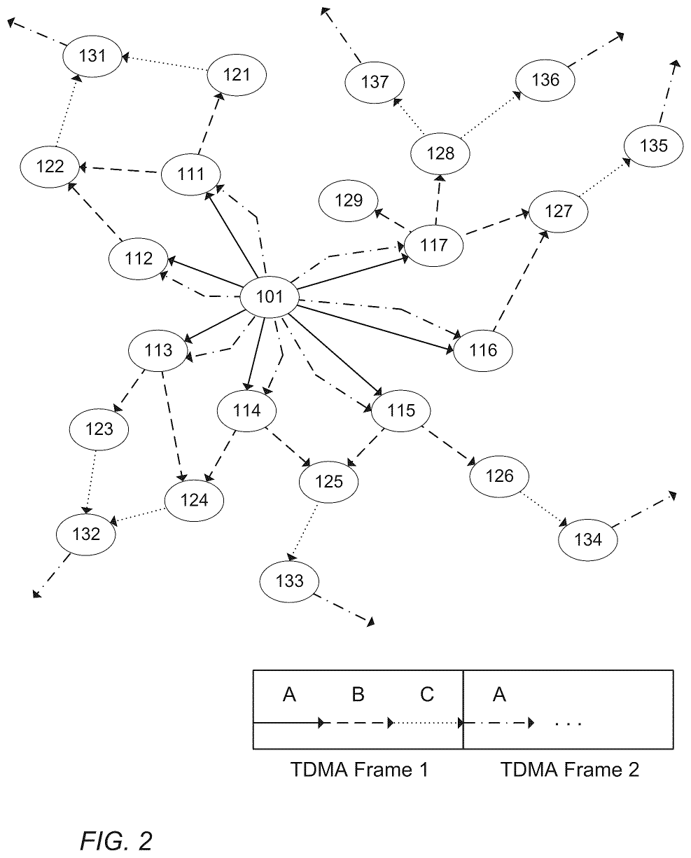

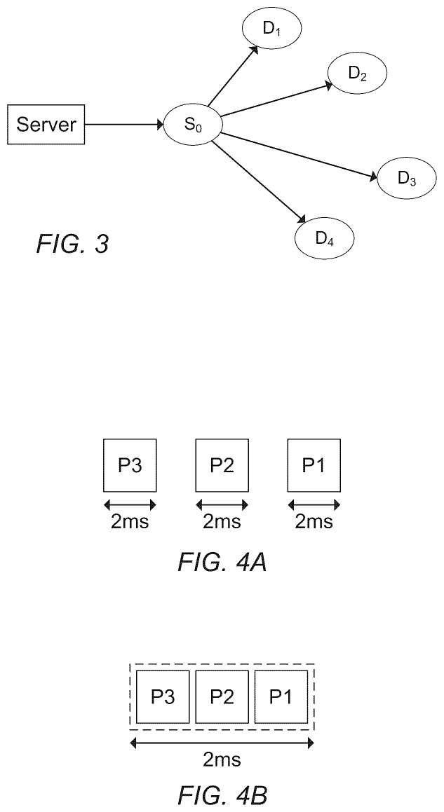

As discussed above, the RTS/CTS mechanism can be used for allocating resources in a time-slotted multi-hop network. In these cases, a source node (e.g., node So in FIG. 3) typically aggregates unicast packets only to one destination node (e.g., any one of nodes D1-D4 in FIG. 3) at the same priority in one MAC Protocol Data Unit (MPDU). To this end, the source node (a) sends one request message per destination node over a contention channel to the NTR for transmission of its MPDU over the network, and (b) receives, from the NTR, a grant of bandwidth resources in the form of data slots, so the source node can transmit the unicast MPDU to the that one destination node over the Barrage Relay network.

However, this framework can be inefficient when the source node is the source of traffic flows to many destinations, e.g. the source node So in FIG. 3, since the source node must request resources (e.g., transmit RTS) and receive an indication of assigned data slots (e.g., receive CTS) for each of those many destinations. Furthermore, the source node then uses each bandwidth grant (that may include multiple slots) to transmit an MPDU to the respective destination in a sequential manner. This baseline approach, which is shown in FIG. 4A, has an increased latency (due to the sequential data transmissions) and reduced throughput (due to the RTS/CTS messages, and likely underutilized resources in the bandwidth grant).

Embodiments of the disclosed technology include unicast aggregation, which leverages the broadcast nature of the Barrage Relay network, and configures the source node to aggregate unicast packets destined for multiple different destinations in one MPDU, as shown in FIG. 4B. In some embodiments, each of the aggregated unicast packets must have the same priority, which maintains quality-of-service (QoS) requirements of the applications or programs corresponding to those unicast packets. As a result of this aggregation, only one request message is sent to the NTR and one bandwidth grant from the NTR is needed to transmit these unicast packets to their destinations over the Barrage Relay network. This advantageously reduces contention channel access significantly and maximizes allocated data bandwidth utilization.

In the described embodiments, when a Unicast Aggregation (UA)-enabled source node forms one or more requests for unicast data transmissions, it first inspects its buffers for priority and destination information of these unicast data frames. When the destination number of unicast data frames of the same priority exceeds a threshold, dynamically set or statically configured, the source node forms a single data transmission request for these data frame at the priority and then transmits such requests to the NTR. Upon successful reception and granting by NTR, the source node forms a single MAC Protocol Data Unit (MPDU) out of the unicast data frames at the priority with the TTL field set to the maximum allowed hop number or the network radius at that time, and then transmits the MPDU over the Barrage Relay network to the destinations.

In some embodiments, the UA-enabled source node can form up to three data transmission requests for these unicast data frames at the same priority whose destinations are 1-hop, 2-hop, and more than 2-hops away from the source node, then correspondingly create up to three MPDUs out of the unicast data frames with the same priority with the TTL field set to 1+safety-factor, 2+safety-factor, and the maximum allowed hop number or the network radius at that time, respectively, and finally, transmit them separately upon NTR transmission grants over the Barrage Relay network to the destinations. Herein, safety-factor is a preconfigured integer (e.g., 0 or 1), which ensures that even if a node moves a bit further away (e.g., an additional hop away), it will still receive the MPDU intended for it. Optionally, the NTR can schedule time slots for the destinations in the two aggregates of 1-hop destinations and 2-hop destinations to transmit their feedback messages to the source node.

In some embodiments, multicast and broadcast data frames originating from the source node may also be packed into the data MPDU that is delivered with the TTL field set to the maximum allowed hop number or the network radius at that time.

In some embodiments, the unicast packets that are aggregated in one MPDU can be further constrained based on the following rules:
each of the unicast packets has the same priority and is destined for a node that is one hop away from the source node;
each of the unicast packets has the same priority and is destined for a node that is two hops or less away from the source node; or
each of the unicast packets has the same priority and is destined for a node that is more than two hops away from the source node.

In some embodiments, multicast and/or broadcast packets with the same priority as one or more unicast packets can be aggregated in one MPDU.

In some examples, and with reference to FIG. 2, assume that the central node 101 has unicast data packets (or unicast data frames) with priority 0 in its data buffers to the following destinations—113, 114, 115, 123, 124, 125, 129, 132, 133, 135, 136, and 137. The central node has the following two options to deliver these unicast data packets to their destinations:
Option 1. Form a single data transmission request with priority field=0, transmission TTL=network default TTL, data size=the total data bytes of these unicast data frames to 113, 114, 115, 123, 124, 125, 129, 132, 133, 135, 136, destination=137 and some reserved broadcast or multicast address. When a transmission request is granted by the NTR, form a single MPDU with the same field values as in the fields in the data transmission request.
Option 2. Form three data transmission requests, all with priority field=0, destination=some reserved broadcast or multicast address, and safety-factor=a preconfigured integer (e.g., 0, 1 or 2). The three requests have the following field values respectively:
   (1) Transmission TTL=1+safety-factor, data size=the total data bytes of the unicast data frames to 113, 114, and 115.
   (2) Transmission TTL=2+safety-factor, data size=the total data bytes of the unicast data frames to 123, 124, 125, and 129.
   (3) Transmission TTL=network default TTL, data size=the total data bytes of these unicast data frames to 132, 133, 135, 136, and 137.

And upon receiving NTR grants, form three MPDUs corresponding to the three requests for data transmissions.

In other examples, and with reference to FIG. 2, assume that the central node 101 has unicast data packets with priority 0 in its data buffers to the following destinations—113, 124, and 135, and two multicast or broadcast packets with priority 0. The central node 101 can form a single data transmission request with priority field=0, transmission TTL=network default TTL, data size=the total data bytes of the unicast data frames to 113, 124, and 135, and the two multicast or broadcast packets, destination=some reserved broadcast or multicast address. When a transmission request is granted by NTR, form a single MPDU out of the unicast and multicast-or-broadcast data frames with the same field values as in the fields of the data transmission request.

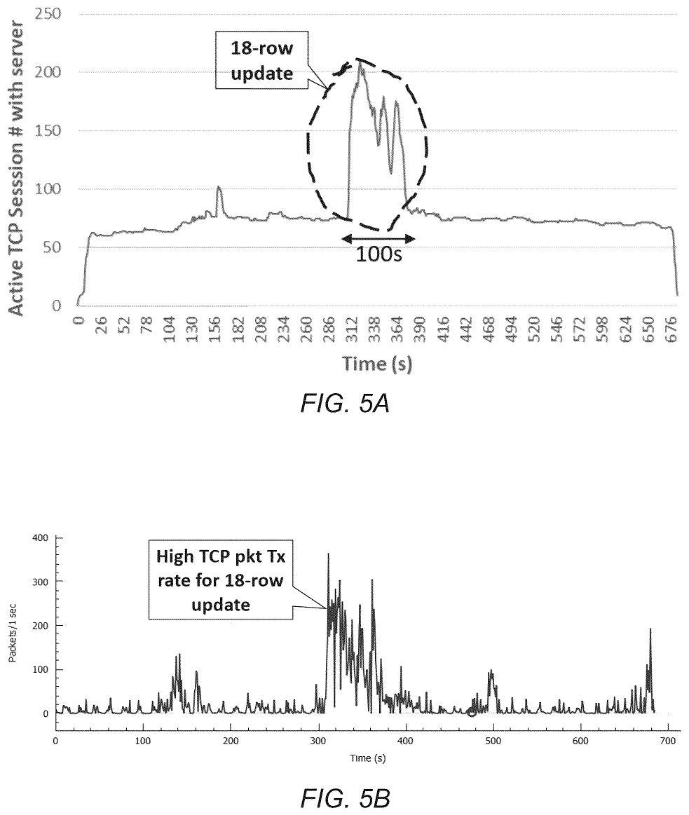

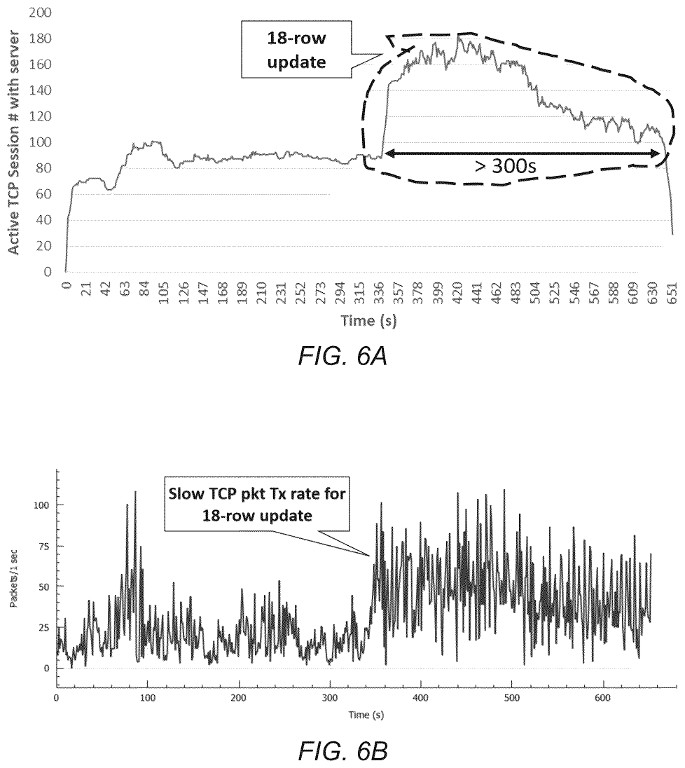

Unicast aggregation (with its results shown in FIGS. 5A and 5B) was compared to the baseline approach (with its results shown in FIGS. 6A and 6B) using a testbed of 30+end-user devices (EUDs), with the traffic source node (or server) being the NTR. To evaluate information dissemination in the testbed network, the ExCheck application was used by one EUD to update 18 rows in a checklist, which triggered identically updating the checklist for all the other subscribed EUDs in the network.

The testbed results for unicast aggregation and the baseline approach are shown in FIGS. 5A-5B and 6A-6B, respectively. FIGS. 5A and 6A shows the active TCP session number (on the x-axis) as a function of time (on the y-axis) when using unicast aggregation and the baseline approach, respectively. Herein, the increase in the number of active TCP sessions corresponds to the 18-row update propagating through the network to all subscribed EUDs. In FIGS. 5B and 6B, the increase in the packet rate corresponds to the propagation of the 18-row update that is triggered by one EUD updating those 18 rows.

As shown in FIG. 5A, the 18-row update is performed in less than 100 seconds when using unicast aggregation, and is accompanied by a high TCP packet transmission rate (as shown in FIG. 5B). In contrast, performing the 18-row update using the baseline approach requires more than 300 seconds (as seen in FIG. 6A), and corresponds to the slower increase in the TCP packet transmission rate seen in FIG. 6B.

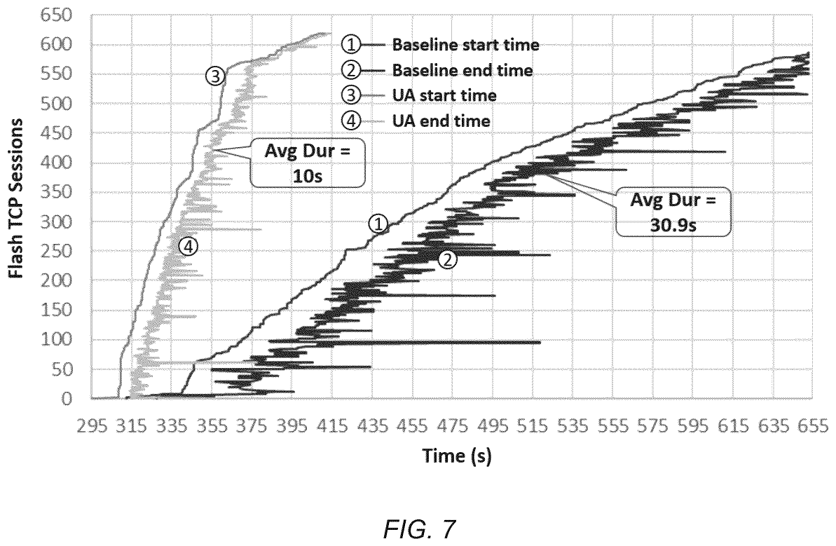

The efficacy of unicast aggregation over the baseline approach is further evidenced in FIG. 7, which shows the start times and end times (on the x-axis) for each of a number of flash TCP sessions (on the y-axis) when using the baseline approach (lines (1) and (2), respectively) and unicast aggregation (lines (3) and (4), respectively). As shown therein, the average duration of a flash TCP session is 10 seconds when using unicast aggregation and 30.9 seconds when using the baseline approach.

Thus, compared to the baseline approach, unicast aggregation increase downlink bandwidth efficiency and substantially mitigates network congestion caused by downlink traffic.

### 3 Example Embodiments for Minimal Pipeline Flushing

As previously discussed, spatial pipelining in a multi-hop time-slotted wireless network can be achieved by having a source node inject a new packet for every barrage relay broadcast every M slots, with M being referred to as the spatial pipelining factor. However, when the source node transmits its last packet, the spatial pipeline must be flushed or cleared, which nominally requires a time corresponding to the network hop diameter and can cause a significant switching cost between source nodes in certain applications. Embodiments of the disclosed technology alleviate some of the switching cost by leveraging the distance between consecutive source nodes so that the next source node can start transmitting early. For example, if the next source node is only one hop away from the current source node, then the next source node could start transmitting M+1 slots after current source node's last packet transmission.

FIG. 8 shows an example of the minimal pipeline flushing procedure in time-slotted multi-hop network. As shown therein, the circle-shaped source node can begin transmitting 6 time slots after the star-shaped source node's last packet transmission since the source nodes are separated by h=2 hops. This ensures that the first transmission of the circle-shaped source node is spatially separated by 4 hops from the last transmission of the star-shaped source node. This is true for any source node that is two hops from the star-shaped source node.

More generally, with a spatial pipelining factor of M, a source node h hops away from the current source node can begin transmitting packets M+h time-slots after the last packet of the current source node. This maintains a spatial hop separation of M between all of the packets sent by both source nodes. If M+h is much less than the network hop diameter, then the switching times between source nodes can be significantly reduced. Thus, instead of waiting the network hop diameter between different source nodes (referred to as a “baseline switching cost”), the next source node need only wait min (M+h; D), where D is the network diameter in hops (referred to as a “schedule-based switching cost”). For an 8-hop network with spatial reuse factor of 4 this reduces the switching cost from the baseline switching cost of 8 to the schedule-based switching cost of 5 in the best case, and provides no reduction in the worst case.

When minimal pipeline flushing is used, and assuming a known switching cost for source node j to follow source node i, the scheduling of queued sources nodes to minimize the sum switching delay can be mapped to the traveling salesperson problem (which is further described in https://en.wikipedia.org/wiki/Travelling_salesman_problem), and dynamic programming solutions can be used to effectively solve for the optimal schedule for the queued source nodes. To demonstrate the efficacy of minimal pipeline flushing (MPF), three approaches are considered:
(1) a full-flush of the spatial pipeline, corresponding to the baseline switching cost
(2) MPF with a random schedule
(3) MPF with an optimal schedule

Simulations show that minimal pipeline flushing with optimal scheduling yields about a 20% to 40% reduction in the average switching time as the number of sources to be scheduled increases from 6 to 24 under typical operating conditions (8-hop network with M=4). In these simulations, the cost (or delay) of switching from source Sᵢ to source Sⱼ is

$${d}_{i , j} = min ( M + {h}_{i , j} , D ) .$$

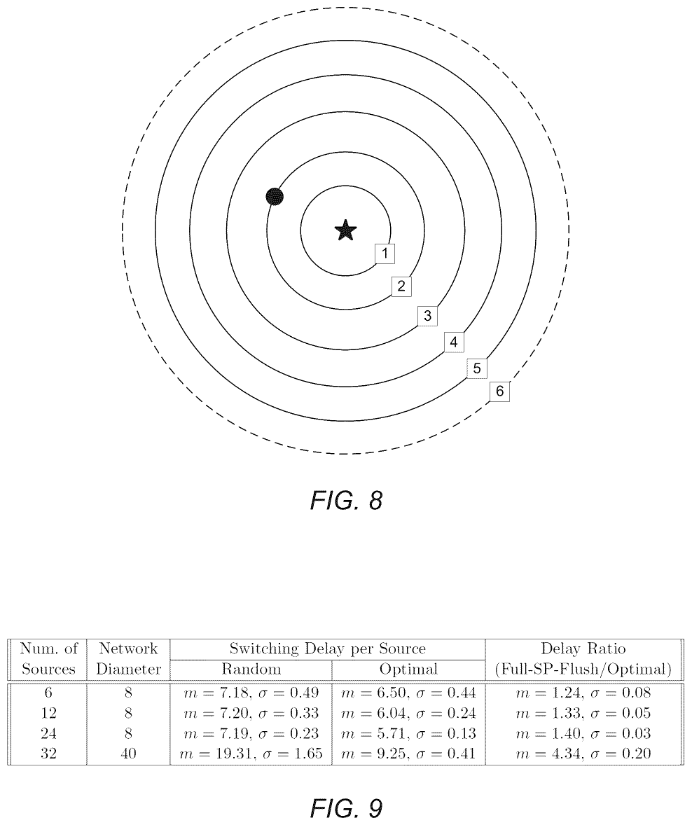

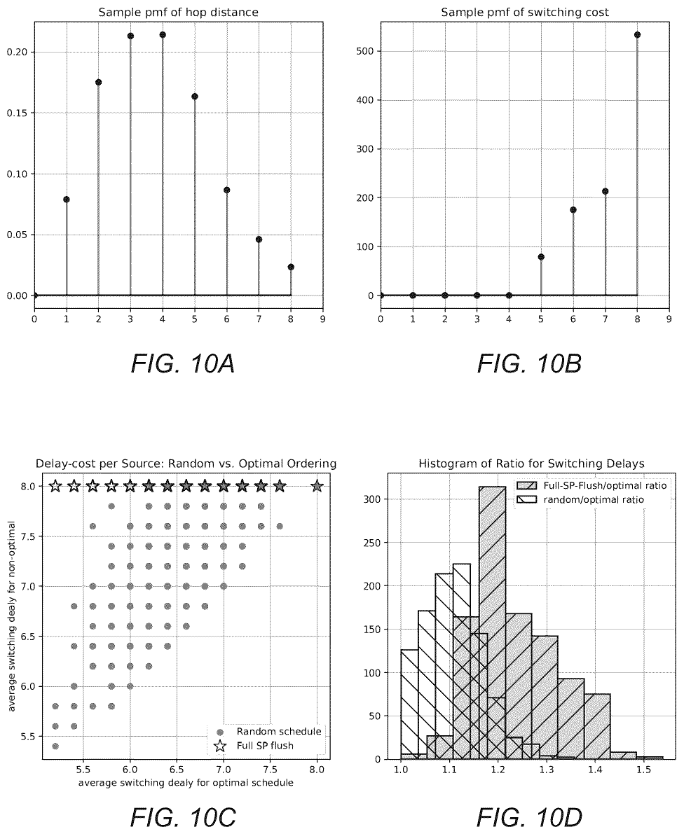

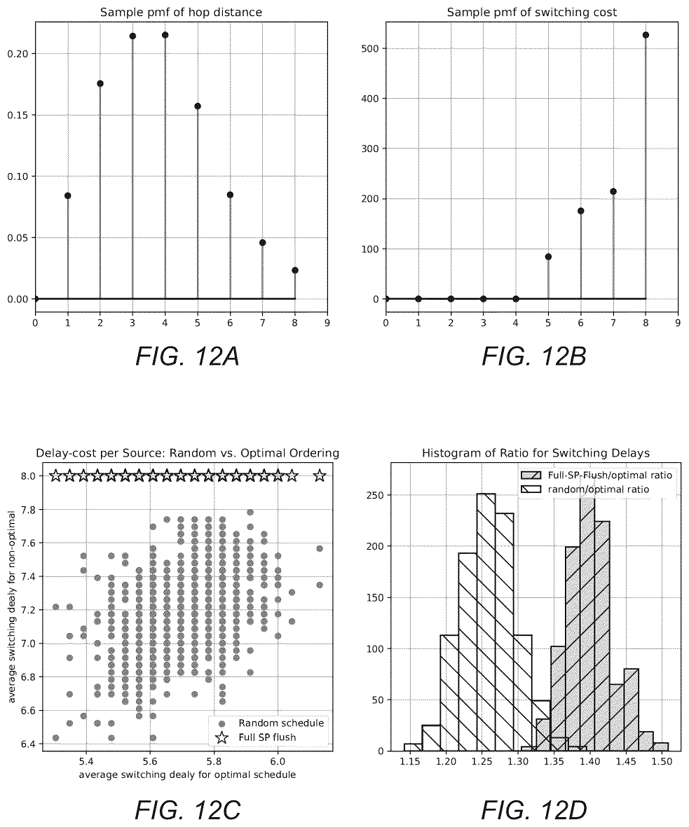

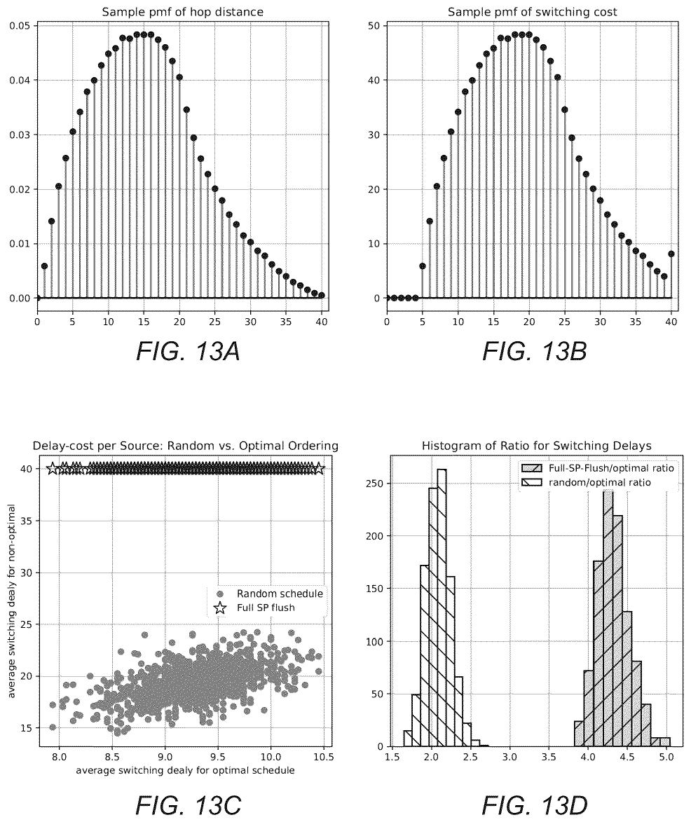

Herein, d_{i,j} is the switching time (or cost) from source i to j (or j to i) when minimal pipeline flushing is used, M is the spatial pipelining factor, h_{i,j} is the distance between sources i and j (in hops), and D is the network diameter in hops. The simulations assumed a network of diameter of D hops, and N sources were randomly placed on a disc representing the network with the Euclidean distance between points being converted to a hop distance based on the assumption that the number of hops between nodes is proportional to the Euclidean distance. The statistics for switching cost per source were computed for a random schedule and for the optimal schedule for a few scenarios with the table in FIG. 9 showing a summary of the results. Therein, sample mean and sample standard deviation are denoted by m and σ, respectively. The traveling salesperson problem (TSP) solver for the first two scenarios was optimal and a heuristic was used in the last two scenarios. The detailed results for each of the rows is shown in FIGS. 10A-10D through FIGS. 13A-13D, respectively.

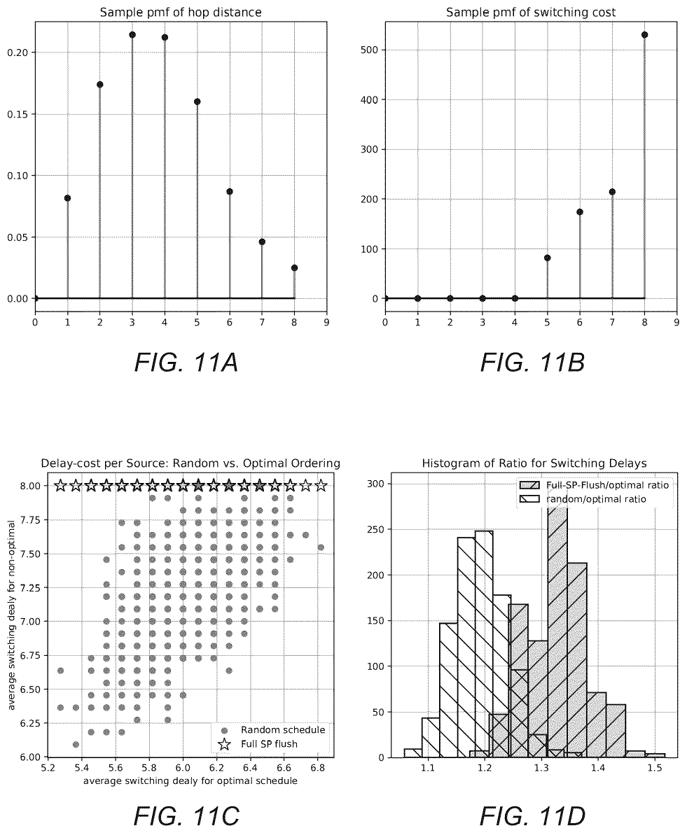

FIGS. 10A-10D show the results for an 8-hop network with 6 source nodes. Therein, FIGS. 10A and 10B show the sample probability mass function (pmf) for the hop distance and switching costs between these randomly placed sources, respectively. The pmf of the hop distance is inherited from the uniformly random distribution of nodes over a circular region. The pmf of the switching costs saturated at 8 because a source never needs to wait more than D slots after the previous source. Also, the minimum switching time is M+1 which is the MPF switching time for nodes that are h=1 hop away. FIG. 10C shows a scatter plot of the switching times for the full pipeline flush and the MPF with random scheduling versus the switching time for MPF with optimal scheduling. FIG. 10D shows histograms of the ratio of the delay per source for the full pipeline flush and the MPF with random scheduling to the delay for MPF with optimal scheduling. The same type of plots are shown in FIGS. 11A-11D through FIGS. 13A-13D for the other three scenarios enumerated in the table shown in FIG. 9.

As seen in the simulation results, the general trend is that the minimal pipeline flushing solution provides 1.5-2 times reduction in the switching delay per source for an 8-hop network with the gain increasing to over 4x for a 40-hop network with 32 sources. The gains increase as the number of sources increase and as the hop diameter of the network increases. Also, the variation in the per source switching delay is quite low for the optimal scheduler. Note that the switching time for full pipeline flushing is always D (8 in this example) and the switching time for MPF with random scheduling is always greater than that of MPF with optimal scheduling.

The results in FIGS. 10A-10D through FIGS. 13A-13D are qualitatively similar with the exception of the extreme case in FIGS. 13A-13D. Specifically, the mass in the pmf for the switching time is compressed at D (in FIGS. 10B, 11B and 12B) implying that the gains associated with minimal pipeline flushing are limited. The extreme case in FIG. 13B is an exception to this where the pmf of the switching time is not collapsed significantly at D. In this case the gains are more significant with MPF and random scheduling yielding a 2× improvement and optimal scheduling yielding another 2× factor.

In the embodiments described above (and whose results are shown in FIGS. 10A-13D), the switching cost between the different sources is specified in terms of the hop distance between nodes (e.g., based on the assumption that the number of hops between nodes is proportional to the Euclidean distance between those nodes). However, the described embodiments need not be limited by switching costs that depend on the hop distance.

In some embodiments, additionally or alternatively, the switching cost (denoted above as d_{i,j} from source Sᵢ to source Sⱼ) can be derived based on the different priorities of the traffic flows. For example, a metric that combined both the hop distance and the traffic priority can be used as the switching cost when determining the order for the N sources in the examples described herein. In yet other embodiments, additionally or alternatively, a latency or a quality-of-service (QoS) for a particular link can be incorporated into the switching cost d_{i,j} for source nodes Sᵢ and Sⱼ, at least one of which use that particular link.

In some embodiments, minimal pipeline flushing without considering source scheduling can provide modest gains (e.g., an average improvement of about 12% in an 8-hop network), with minimal additional complexity (since the dynamic programming solvers, which are used only when an optimal schedule is sought, are not required).

### 4 Example Embodiments and Implementations of the Disclosed Technology

The described embodiments advantageously combine unicast aggregation and minimal pipeline flushing (e.g., with random source scheduling) to improve network communications, and can be implemented with relatively low complexity and independently of other non-NTR nodes in the network.

In the example of a large multi-hop wireless network, application servers (e.g., an FTP server and/or a TAK server) are running on one or more nodes or are in a wired network but connected to wireless network via one or more gateway nodes. Other nodes running as unicast-based application clients need to communicate with the servers via applications. In order to benefit from combined UA/MPF, unicast aggregation is activated in nodes that host the application servers or the gateway nodes and the NTR supports minimal pipeline flushing.

In the example of a pure peer-to-peer multi-hop wireless network, each node hosts one or more unicast application server (e.g., FTP server and/or TAK server). These nodes need to communicate with each other via a client/server application for data sharing. In order to benefit from combined UA/MPF, unicast aggregation is activated in all the nodes and the NTR supports minimal pipeline flushing.

Embodiments of the disclosed technology include a system for wireless communication in a time-slotted multi-hop wireless network with a network diameter of D hops and a spatial reuse factor of M. This system includes a first source node, a first destination node, a second source node that is h hops away from the first source node, a second destination node, and a plurality of intermediate nodes. Herein, the first source node configured to receive a first plurality of packets, identify, using a destination field in each of the first plurality of packets, a first set of packets to be transmitted to the first destination node and a second set of packets to be transmitted to the second destination node, aggregate the first set of packets and the second set of packets into a first packet data unit (PDU), and broadcast, in a first timeslot, the first PDU. In addition, the second source node is configured to receive a second plurality of packets, identify, using the destination field in each of the second plurality of packets, a third set of packets to be transmitted to the first destination node, aggregate the third set of packets into a second PDU, and broadcast, in a second timeslot that is min (M+h, D) timeslots after the first timeslot, the second PDU. In this system, each of the plurality of intermediate nodes, the first destination node, and the second destination node is configured to receive multiple instances of a packet. Each of the plurality of intermediate nodes is further configured to constructively combine energy from a first subset of the multiple instances of the packet before relaying a constructively combined packet via a broadcast operation. Each of the first destination node and the second destination node is further configured to constructively combine energy from a second subset of the multiple instances of the packet before decoding the constructively combined packet.

In some embodiments, the above-described system further includes a network controller node configured to receive, from the first source node prior to the first PDU being broadcast, a request message for resources to broadcast the first set of packets to the first destination node and the second set of packets to the second destination node; allocate, in response to the request message for resources, the first timeslot; and transmit, to the first source node, an indication of the first timeslot.

In some embodiments, and in the above-described system, the first plurality of packets or the second plurality of packets is received from a backbone-type network or a third source node different from the first source node and the second source node.

In some embodiments, and in the above-described system, each of the first set of packets and each of the second set of packets has a same priority. In some examples, the first and second destination nodes are both one hop away from the first source node. In other examples, the first and second destination nodes are both no more than two hops away from the first source node. In yet other examples, the first and the second destination nodes are both greater than two hops away from the first source node.

In some embodiments, and in the above-described system, each of the first plurality of packets is a unicast packet.

In some embodiments, and in the above-described system, the first plurality of packets or the second plurality of packets comprises at least one of a unicast packet, a multicast packet, or a broadcast packet.

In some embodiments, and in the above-described system, each of the first PDU and the second PDU is a medium access control (MAC) PDU.

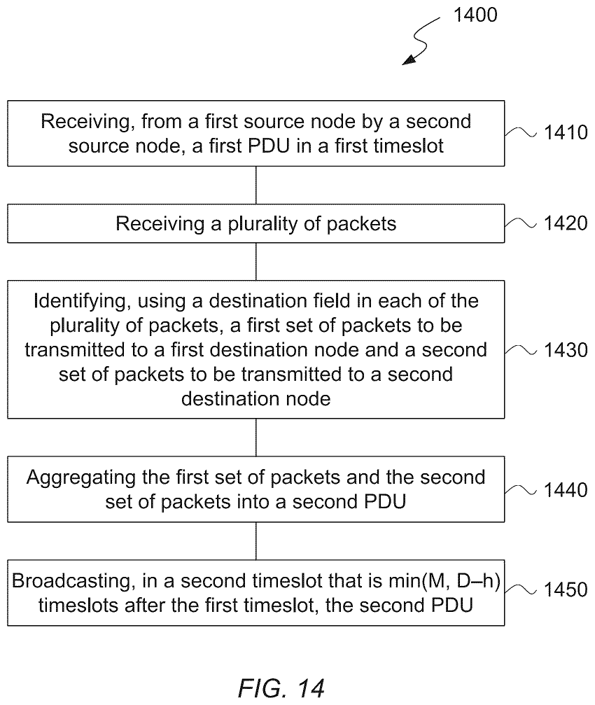

FIG. 14 is a flowchart for an example method 1400 for wireless communication in a time-slotted multi-hop wireless network with a network diameter of D hops and a spatial reuse factor of M. In some embodiments, the method 1400 can be implemented by a second source node that transmits after a first source node in the time-slotted multi-hop wireless network.

The method 1400 includes, at operation 1410, receiving, from a first source node by a second source node via a plurality of intermediate nodes, a first packet data unit (PDU) in a first timeslot. In example method 1400, the first source node and the second source node are h hops away from each other.

The method 1400 includes, at operation 1420, receiving a plurality of packets.

The method 1400 includes, at operation 1430, identifying, using a destination field in each of the plurality of packets, a first set of packets to be transmitted to a first destination node and a second set of packets to be transmitted to a second destination node.

The method 1400 includes, at operation 1440, aggregating the first set of packets and the second set of packets into a second PDU.

The method 1400 includes, at operation 1450, broadcasting, in a second timeslot that is min (M, D-h) timeslots after the first timeslot, the second PDU.

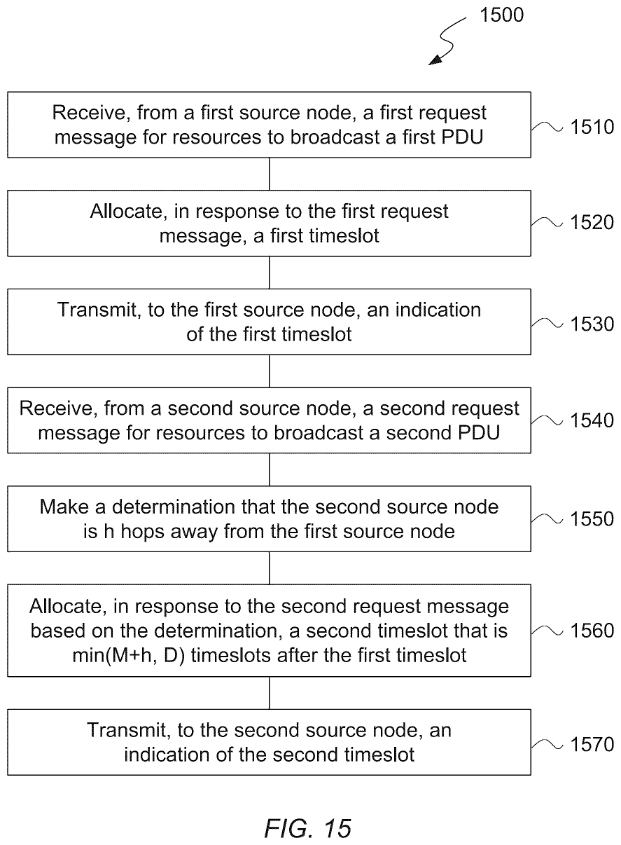

FIG. 15 is a flowchart for an example method 1500 for wireless communication in a time-slotted multi-hop wireless network with a network diameter of D hops and a spatial reuse factor of M. In some embodiments, the method 1500 can be implemented by a network controller node in the time-slotted multi-hop wireless network.

The method 1500 includes, at operation 1510, receive, from a first source node, a first request message for resources to broadcast a first packet data unit (PDU). In method 1500, a first set of packets to a first destination node and a second set of packets to a second destination node are aggregated into the first PDU.

The method 1500 includes, at operation 1520, allocate, in response to the first request message, a first timeslot.

The method 1500 includes, at operation 1530, transmit, to the first source node, an indication of the first timeslot.

The method 1500 includes, at operation 1540, receive, from a second source node, a second request message for resources to broadcast a second PDU. Herein, a third set of packets to the first destination node and a fourth set of packets to the second destination node are aggregated into the second PDU.

The method 1500 includes, at operation 1550, make a determination that the second source node is h hops away from the first source node.

The method 1500 includes, at operation 1560, allocate, in response to the second request message based on the determination, a second timeslot that is min (M+h, D) timeslots after the first timeslot.

The method 1500 includes, at operation 1570, transmit, to the second source node, an indication of the second timeslot.

In some embodiments, the network controller node is configured to allocate timeslots to nodes in the time-slotted multi-hop wireless network.

In some embodiments, the second timeslot is min (M+h, D)+T_{L} timeslots after the first timeslot, with TL being based on a priority of the second request message. In some examples, TL can be further based on the latency or QoS of a link that is traversed to transmit the second PDU to the first and second destination nodes. In other examples, the floor( ) and ceiling( ) function is used when computing (min (M+h, D)±T_{L}) to determine the second timeslot.

In some embodiments, and for methods 1400 and 1500, each of the destination nodes receives a PDU via a plurality of intermediate nodes. Herein, each of the plurality of intermediate nodes, the first destination node, and the second destination node is configured to receive multiple instances of a packet; each of the plurality of intermediate nodes is further configured to constructively combine energy from a first subset of the multiple instances of the packet before relaying a constructively combined packet via a broadcast operation; and each of the first destination node and the second destination node is further configured to constructively combine energy from a second subset of the multiple instances of the packet before decoding the constructively combined packet.

In some embodiments, and for methods 1400 and 1500, each of the first set of packets and each of the second set of packets has a same priority. In some examples, the first destination node and the second destination node are both one hop away from the first source node. In other examples, the first destination node and the second destination node are both no more than two hops away from the first source node. In yet other examples, the first destination node and the second destination node are both greater than two hops away from the first source node.

In some embodiments, and for methods 1400 and 1500, the first set of packets is received from a backbone-type network or a third source node different from the first source node and the second source node.

In some embodiments, and for methods 1400 and 1500, the first set of packets comprises at least one of a unicast packet, a multicast packet, or a broadcast packet.

In some embodiments, and for methods 1400 and 1500, each of the first PDU and the second PDU is a medium access control (MAC) PDU.

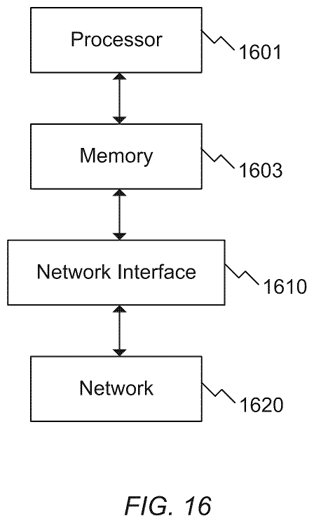

FIG. 16 is a block diagram of an example device implemented as a node (e.g., a source node) for wireless communication in a time-slotted multi-hop wireless network, in accordance with embodiments of the disclosed technology. As shown therein, the system comprises a processor 1601, a memory 1603, a network interface 1610, and a network 1620.

The processor 1601 shown in FIG. 16 may comprise component digital processors and may be configured to execute computer-executable program instructions stored in memory 1603. For example, the component digital processors may execute one or more computer programs in accordance with embodiments of the present invention.

Processor 1601 may comprise a variety of implementations for broadcasting or re-broadcasting a transmission, and evaluating a trade-off between power consumption and communication reliability, as well as a microprocessor, a digital signal processor (DSP), an application-specific integrated circuit (ASIC), one or more field programmable gate arrays (FPGAs), state machines, or the like. Processor 1601 may further comprise a programmable electronic device such as a programmable logic controller (PLC), a programmable interrupt controller (PIC), a programmable logic device (PLD), a programmable read-only memory (PROM), an electronically programmable read-only memory (EPROM or EEPROM), or another similar device.

Memory 1603 may comprise a non-transitory computer-readable medium that stores instructions which, when executed by the processor 1601, cause the processor 1601 to perform various steps, such as those described herein. Examples of computer-readable media include, but are not limited to, electronic, optical, magnetic, or other storage or transmission devices capable of providing the processor 1601 with computer-readable instructions. Other examples of computer-readable media comprise, but are not limited to, a floppy disk, CD-ROM, magnetic disk, memory chip, ROM, RAM, ASIC, configured processor, any optical medium, any magnetic tape or other magnetic medium, or any other medium from which a computer processor can access data. In addition, various other devices may include a computer-readable medium such as a router, private or public network, or other transmission device. The processor 1601 and the processing described may be in one or more structures, and may be dispersed throughout one or more structures.

Processor 1601 is in communication with the network interface 1610 via the memory 1603. The network interface 1610 may comprise one or more network connections. Network interface 1610 connects the processor 1601 and the memory 1603 to a network 1620. The network 1620 may be one of many types of networks known in the art. In some examples, the network 1620 can be a wired network. In other examples, the network 1620 can be a wireless network, e.g., a Barrage Relay network. In these examples, the processor 1601, the memory 1603, and the network interface 1610 are implemented in a source node (e.g., node SO in FIG. 3, or the circle—and star-shaped source nodes in FIG. 8) that is part of, and communicatively coupled to, the network 1620.

Embodiments in accordance with aspects of the present subject matter can be implemented in digital electronic circuitry, computer hardware, firmware, software, or in combinations of the preceding. In one embodiment, a computer may comprise a processor or processors. A processor comprises or has access to a computer-readable medium, such as a random access memory (RAM) coupled to the processor.

While the present subject matter has been described in detail with respect to specific embodiments thereof, it will be appreciated that those skilled in the art, upon attaining an understanding of the foregoing, may readily produce modifications to, variations of, and equivalents to such embodiments. Accordingly, it should be understood that the present disclosure has been presented for purposes of example rather than limitation, and does not preclude inclusion of such modifications to, variations of and/or additions to the present subject matter as would be readily apparent to one of ordinary skill in the art.

What is claimed is:

1. A system for wireless communication, comprising:
a plurality of nodes,
wherein each of the plurality of nodes is configured to operate in a network,
wherein the network is configured to operate as a time-slotted multi-hop wireless network having a diameter of D hops and a spatial reuse factor of M,
wherein the plurality of nodes comprises:
a first destination node;
a second destination node;
a first source node configured to:
receive a first plurality of packets,
identify, using a destination field in each of the first plurality of packets, a first set of packets to be transmitted to the first destination node and a second set of packets to be transmitted to the second destination node,
aggregate the first set of packets and the second set of packets into at least a first packet data unit (PDU), and
broadcast, in a first timeslot, the first PDU;
a second source node, h hops away from the first source node, configured to:
receive a second plurality of packets,
identify, using the destination field in each of the second plurality of packets, a third set of packets to be transmitted to the first destination node,
aggregate the third set of packets into a second PDU, and
broadcast, in a second timeslot that is min (M+h, D) timeslots after the first timeslot, the second PDU; and
a plurality of intermediate nodes,
wherein each of the plurality of intermediate nodes, the first destination node, and the second destination node is configured to:
receive multiple instances of a packet,
wherein each of the plurality of intermediate nodes is further configured to:
constructively combine energy from a first subset of the multiple instances of the packet before relaying a constructively combined packet via a broadcast operation, and
wherein each of the first destination node and the second destination node is further configured to:
constructively combine energy from a second subset of the multiple instances of the packet before decoding the constructively combined packet.

2. The system of claim 1, wherein the first plurality of packets or the second plurality of packets is received from a backbone-type network or a third source node different from the first source node and the second source node.

3. The system of claim 1, wherein each of the first set of packets and each of the second set of packets has a same priority.

4. The system of claim 3, wherein the first destination node and the second destination node are both one hop away from the first source node.

5. The system of claim 3, wherein the first destination node and the second destination node are both no more than two hops away from the first source node.

6. The system of claim 3, wherein the first destination node and the second destination node are both greater than two hops away from the first source node.

7. The system of claim 1, further comprising:
a network controller node configured to:
receive, from the first source node prior to the first PDU being broadcast, a request message for resources to broadcast the first set of packets to the first destination node and the second set of packets to the second destination node;
allocate, in response to the request message for resources, the first timeslot; and
transmit, to the first source node, an indication of the first timeslot.

8. The system of claim 1, wherein each of the first plurality of packets is a unicast packet.

9. The system of claim 1, wherein the first plurality of packets or the second plurality of packets comprises at least one of a unicast packet, a multicast packet, or a broadcast packet.

10. The system of claim 1, wherein each of the first PDU and the second PDU is a medium access control (MAC) PDU.

11. A method of wireless communication, comprising:
receiving, from a first source node by a second source node via a plurality of intermediate nodes, a first packet data unit (PDU) in a first timeslot,
wherein a network comprising the first source node, the second source node, and the plurality of intermediate nodes is configured to operate as a time-slotted multi-hop wireless network having a diameter of D hops and a spatial reuse factor of M,
wherein the first source node and the second source node are h hops away;
receiving a plurality of packets;
identifying, using a destination field in each of the plurality of packets, a first set of packets to be transmitted to a first destination node of the network and a second set of packets to be transmitted to a second destination node of the network;
aggregating the first set of packets and the second set of packets into a second PDU; and
broadcasting, in a second timeslot that is min (M, D-h) timeslots after the first timeslot, the second PDU,
wherein the first destination node and the second destination node receive the second PDU via the plurality of intermediate nodes,
wherein each of the plurality of intermediate nodes, the first destination node, and the second destination node is configured to:
receive multiple instances of a packet,
wherein each of the plurality of intermediate nodes is further configured to:
constructively combine energy from a first subset of the multiple instances of the packet before relaying a constructively combined packet via a broadcast operation, and
wherein each of the first destination node and the second destination node is further configured to:
constructively combine energy from a second subset of the multiple instances of the packet before decoding the constructively combined packet.

12. The method of claim 11, wherein each of the first set of packets and each of the second set of packets has a same priority.

13. The method of claim 12, wherein the first destination node and the second destination node are both one hop away from the first source node.

14. The method of claim 12, wherein the first destination node and the second destination node are both no more than two hops away from the first source node.

15. The method of claim 12, wherein the first destination node and the second destination node are both greater than two hops away from the first source node.

16. A device for wireless communication in a time-slotted multi-hop wireless network with a network diameter of D hops and a spatial reuse factor of M, the device comprising:
one or more processors, implemented in a network controller node, configured to:
receive, from a first source node, a first request message for resources to broadcast a first packet data unit (PDU), wherein a first set of packets to a first destination node and a second set of packets to a second destination node are aggregated into the first PDU;
allocate, in response to the first request message, a first timeslot;
transmit, to the first source node, an indication of the first timeslot;
receive, from a second source node, a second request message for resources to broadcast a second PDU, wherein a third set of packets to the first destination node and a fourth set of packets to the second destination node are aggregated into the second PDU;
make a determination that the second source node is h hops away from the first source node;
allocate, in response to the second request message based on the determination, a second timeslot that is min (M+h, D) timeslots after the first timeslot; and
transmit, to the second source node, an indication of the second timeslot,
wherein the first PDU is transmitted from the first source node to the first destination node via a plurality of intermediate nodes,
wherein each of the plurality of intermediate nodes, the first destination node, and the second destination node is configured to:
receive multiple instances of a packet,
wherein each of the plurality of intermediate nodes is further configured to:
constructively combine energy from a first subset of the multiple instances of the packet before relaying a constructively combined packet via a broadcast operation, and
wherein each of the first destination node and the second destination node is further configured to:
constructively combine energy from a second subset of the multiple instances of the packet before decoding the constructively combined packet.

17. The device of claim 16, wherein the network controller node is configured to allocate timeslots to nodes in the time-slotted multi-hop wireless network.

18. The device of claim 16, wherein:
the first set of packets is received from a backbone-type network or a third source node different from the first source node and the second source node, or
the first set of packets comprises at least one of a unicast packet, a multicast packet, or a broadcast packet.

19. The device of claim 16, wherein the second timeslot is min (M+h, D)±T_{L} timeslots after the first timeslot, and wherein T_{L} is based on a priority of the second request message.

20. The device of claim 16, wherein each of the first PDU and the second PDU is a medium access control (MAC) PDU.
